(19) United States
(12) Patent Application Publication
(10) Pub. No.: US 2022/0222006 A1
(43) Pub. Date: Jul. 14, 2022

(54) IN-DEVICE HANDLING OF FILE AND OBJECT LIFE CYCLE

(71) Applicant: Seagate Technology LLC, Fremont, CA (US)

(72) Inventors: Kian Wee Tan, Singapore (SG); Lynette Shi Yun Neo, Singapore (SG); Alphonsus John Kwok Kwong Heng, Singapore (SG)

(21) Appl. No.: 17/148,887

(22) Filed: Jan. 14, 2021

(51) Int. Cl. G06F 3/06; G06N 20/00

(52) U.S. Cl. CPC G06F 3/0649; G06F 3/0652; G06N 20/00; G06F 3/0688; G06F 3/0608

(57) ABSTRACT

Devices and/or methods may monitor data objects stored on a storage medium to detect presence of data objects that have not been accessed for a threshold period of time. Responsive to detecting that a data object has not been accessed for that threshold period of time, devices and methods may determine whether to perform an operation on the data object. The operation may include one or more of deleting the data object, purging the data object, converting the data object, compressing the data object, or transferring the data object to another storage device.

The disclosure herein relates to life cycle management of data objects on a storage device.

### SUMMARY

One example system may include a storage medium comprising a plurality of data objects and a computing apparatus comprising processing circuitry operably coupled to the storage medium.

The storage medium may include a plurality of data objects. The computing apparatus may be configured to monitor the plurality of data objects to detect presence of data objects that have not been accessed for a threshold period of time. Responsive to detecting that a data object of the plurality of data objects has not been accessed for that threshold period of time, the computing apparatus may determine whether to perform an operation on the data object. The operation may include one or more of deleting the data object, purging the data object, converting the data object, compressing the data object, or transferring the data object to another storage device.

One example non-transitory computer-readable medium may include instructions that, when implemented on a processor, cause the processor to perform operations including monitoring a plurality of data objects on a storage device coupled to the processor. The operations can further include detecting that a data object of the plurality has not been accessed for a threshold period of time. The operations can further include, responsive to the detecting, determining whether to perform an operation on the data object. The operation may include one or more of deleting the data object, purging the data object, converting the data object, compressing the data object, or transferring the data object to another storage device.

One example method may include responsive to detecting, by a processor of a storage device, that a data object of a plurality of data objects stored on the storage device has not been accessed for a threshold period of time, determining whether to perform an operation on the data object. The operation may include one or more of deleting the data object, purging the data object, converting the data object, compressing the data object, or transferring the data object to another storage device.

Another example system can include a storage device and a host computer communicatively coupled to the storage device. The host computer may be configured to set file system metadata of a plurality of data objects stored on the storage device. The storage device may be configured to, responsive to detecting that a data object of the plurality of data objects has not been accessed for a threshold period of time, access the file system metadata corresponding to the data object to determine whether to perform an operation on the data object. The operation may include one or more of deleting the data object, purging the data object, converting the data object, compressing the data object, or transferring the data object to another storage device.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1 is a block diagram providing an overview of example components for a computer.

FIG. 2 is a block diagram of a device that can include a storage medium and storage medium processor for implementing operations associated with the storage medium according to example embodiments.

FIG. 3 is a block diagram of a data object including metadata according to example embodiments.

FIG. 4 is a flow diagram of a method for data object life cycle handling according to example embodiments.

### DETAILED DESCRIPTION

Storage devices in use today store data objects for indefinite periods of time until an external host is used to purge, move, or otherwise delete those data objects from that particular storage device. Consequently, old data objects or data objects no longer of interest to the user may take up space on the storage device, leading to low memory conditions and a general deterioration in user experience. Furthermore, even when host software is used to back up data objects to a cloud or network attached storage (NAS), a copy of the data is typically made on the storage device, further taking up space, and the backup software itself can cause system slowdowns. Storage device users may also avoid storing data objects to the storage device to avoid filling up that storage device, and therefore fail to take full advantage of storage device equipment.

The example devices and methods described herein may offload backup operations and other operations from the host to the storage devices themselves. This allows the host to perform other host tasks without system slowdown, while the storage device/s remain powered on to perform operations to handled aged data objects. Example devices and methods allow the storage device/s to handle data object lifecycles by allowing a host or other system to set an expiration period on individual data objects or data object types/classes stored in the storage device. When a data object is determined to have expired, based on various criteria, the storage device can perform different actions on that data object, as will be described in more detail below.

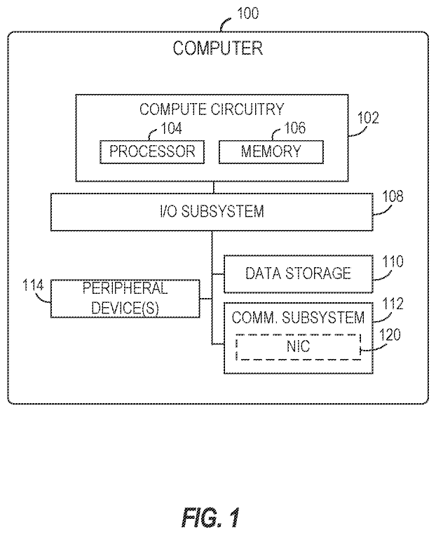

FIG. 1 is a block diagram providing an overview of example components for a computer 100 that can incorporate a storage device and other components for performing methods according to embodiments. The computer 100 includes a compute engine (also referred to herein as “compute circuitry”) 102, an input/output (I/O) subsystem 108, data storage medium 110, a communication circuitry subsystem 112, and, optionally, one or more peripheral devices 114. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The computer 100 may be embodied as any type of engine, device, or collection of devices capable of performing various compute functions. In some examples, the computer 100 may be embodied as a single device such as an integrated circuit, an embedded system, a field-programmable gate array (FPGA), a system-on-a-chip (SOC), or other integrated system or device. In some examples, the computer 100 can act as a host for performing operations with the data storage medium 110 as will be described later herein.

In the illustrative example, the computer 100 includes or is embodied as a processor 104 and a memory 106. The processor 104 may be embodied as any type of processor capable of performing the functions described herein (e.g., executing an application). For example, the processor 104 may be embodied as a multi-core processor(s), a microcontroller, or other processor or processing/controlling circuit. In some examples, the processor 104 may be embodied as, include, or be coupled to an FPGA, an application specific integrated circuit (ASIC), reconfigurable hardware or hardware circuitry, or other specialized hardware to facilitate performance of the functions described herein.

The compute circuitry 102 is communicatively coupled to other components of the computer 100 via the I/O subsystem 108, which may be embodied as circuitry and/or components to facilitate input/output operations with the compute circuitry 102 (e.g., with the processor 104 and/or the main memory 106) and other components of the compute circuitry 102. For example, the I/O subsystem 108 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 108 may form a portion of a system-on-a-chip (SoC) and be incorporated, along with one or more of the processors 104, the memory 106, and other components of the compute circuitry 102, into the compute circuitry 102.

The communication circuitry 112 may be embodied as any communication circuit, device, or collection thereof, capable of enabling communications over a network between the compute circuitry 102 and another compute device (e.g., an edge gateway of an implementing edge computing system). The communication circuitry 112 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 112 includes a network interface controller (NIC) 120. The NIC 120 may be embodied as one or more add-in-boards, daughter cards, network interface cards, controller chips, chipsets, or other devices that may be used by the computer 100 to connect with another compute device (e.g., an edge gateway node). In some examples, the NIC 120 may be embodied as part of a system-on-a-chip (SoC) that includes one or more processors or included on a multichip package that also contains one or more processors. In some examples, the NIC 120 may include a local processor (not shown) and/or a local memory (not shown) that are both local to the NIC 120. In such examples, the local processor of the NIC 120 may be capable of performing one or more of the functions of the compute circuitry 102 described herein. Additionally, or alternatively, in such examples, the local memory of the NIC 120 may be integrated into one or more components of the client compute node at the board level, socket level, chip level, and/or other levels.

Additionally, in some examples, a respective computer 100 may include one or more peripheral devices 114. Such peripheral devices 114 may include any type of peripheral device found in a compute device or server such as audio input devices, a display, other input/output devices, interface devices, and/or other peripheral devices, depending on the particular type of the computer 100. In further examples, the computer 100 may be embodied by a respective edge compute node or a cloud compute node (whether a client, gateway, or aggregation node) in an edge computing system or like forms of appliances, computers, subsystems, circuitry, or other components.

The memory 106 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include various types of random-access memory (RAM), such as DRAM or static random-access memory (SRAM). One particular type of DRAM that may be used in a memory module is synchronous dynamic random-access memory (SDRAM).

Non-volatile memory may include any kind of computer memory that can retain information stored thereon when not powered. Examples of non-volatile memory may include, but are not limited to, hard drives, solid state drives, read only memory (ROM), flash memory, and random-access memory (RAM). Examples of ROM include, but are not limited to, programmable ROM (PROM) which can also be referred to as field programmable ROM; electrically erasable programmable ROM (EEPROM) which is also referred to as electrically alterable ROM (EAROM); and erasable programmable ROM (EPROM). Examples of RAM include, but are not limited to, ferroelectric RAM (FeRAM or FRAM); magnetoresistive RAM (MRAM); resistive RAM (RRAM); non-volatile static RAM (nvSRAM); battery backed static RAM (BBSRAM); phase change memory (PCM) which is also referred to as PRAM, PCRAM and C-RAM; programmable metallization cell (PMC) which is also referred to as conductive-bridging RAM or CBRAM; nano-RANI (NRAM), spin torque transfer RAM (STTRAM) which is also referred to as STRAM; and Silicon-Oxide-Nitride-Oxide-Silicon (SONOS), which is similar to flash RAM.

In an example, the memory device is a block addressable memory device, such as those based on NAND or NOR technologies. In some examples, all or a portion of the memory 106 may be integrated into the processor 104. The memory 106 may store various software and data used during operation such as one or more applications, data operated on by the application(s), libraries, and drivers.

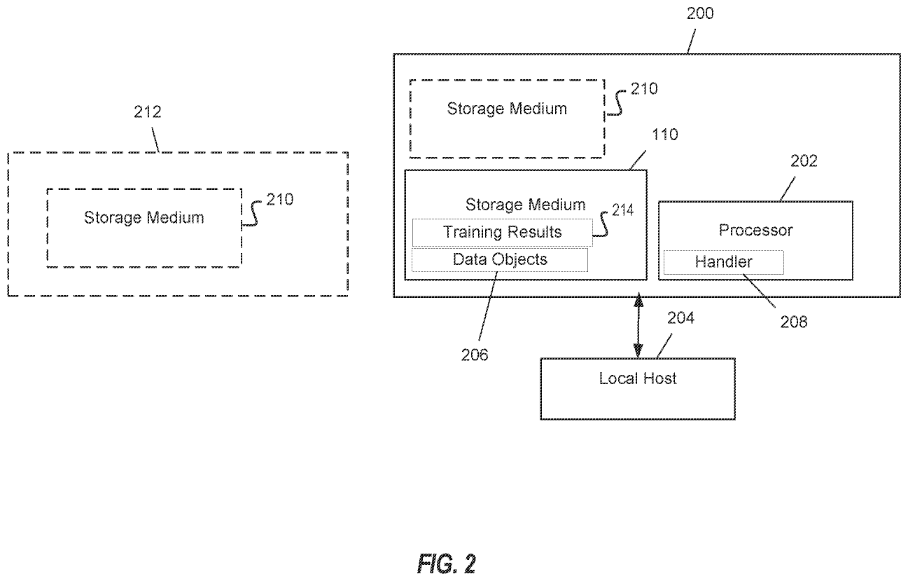

The illustrative storage medium 110 may be embodied as any type of device configured for short-term or long-term storage of data such as, for example, memory devices and circuits, memory cards, hard disk drives, solid-state drives, or other data storage devices. Individual data storage media 110 may include a system partition that stores data and firmware code for the data storage medium 110. Individual data storage media 110 may also include one or more operating system partitions that store data files and executables for operating systems depending on, for example, the type of computer 100. The storage media 110 may be incorporated in one housing with a dedicated processor, as is described below with reference to FIG. 2.

FIG. 2 is a block diagram of a computing apparatus 200 that can include the storage medium 110 and processing circuitry 202 for implementing operations associated with the storage medium 110 according to example embodiments. The computing apparatus 200 may be operably coupled to a local host 204 (e.g., similarly to the computer 100 illustrated in more detail with respect to FIG. 1) for transferring data therebetween. For example, the local host 204 may request data from the computing apparatus 200 and the computing apparatus 200 may provide such requested data to the local host 204 or the local host 204 may send data to the computing apparatus 200 to be stored. In at least one embodiment, the local host 204 is a computer (such as, e.g., a personal computer, server, or the computer 100 (FIG. 1)). The computing apparatus 200 includes the storage medium 110, and processing circuitry 202 that are operably coupled (e.g., electrically coupled to transmit data therebetween) to each other. In some embodiments, the processing circuitry 202 can be incorporated on a SoC separate from the local host 204. The methods and devices disclosed herein may be generally described in the context of example computing apparatus 200 and/or systems including example computing apparatus 200, but that should in no way be taken as limiting the scope of the present disclosure. Generally, a computing apparatus 200 may be any device and/or apparatus in which data may be written to the storage medium 110 and then read back from the storage medium 110. The housing of computing apparatus 200 can comprise the storage medium 110 and the processing circuitry 202. In some embodiments, computing apparatus 200 is sold as a complete unit including the storage medium 110 and the processing circuitry 202. The storage medium 110 may be configured to store a plurality of data objects 206 (e.g., files, binary data, etc.).

The processing circuitry 202 may include various circuitry, logic, memory, etc. for use in the detecting and writing data from the storage medium 110. For example, the processing circuitry 202 may include one or more circuit components such as integrated circuits, processors, etc. that may be configured to interface with the storage medium 110, including handler circuitry 208 that can perform operations on data objects 206 according to systems and methods described herein.

As briefly described earlier herein, storage devices (e.g., the storage medium 110) store data objects 206 for indefinite periods of time until an external host (e.g., local host 204) is used to purge, move, or otherwise delete those data objects 206 from storage medium 110. Consequently, old data objects 206 or data objects 206 that are otherwise no longer of interest to the user may take up space on the storage medium 110, leading to low memory conditions and a general deterioration in user experience. The computing apparatus 200 including storage medium 110 and processing circuitry 202 can perform methods described herein to offload backup operations and other operations from the host 204 to computing apparatus 200.

The computing apparatus 200 can handle old, expired, near-end-of-life or end-of-life data objects 206 by allowing a user (e.g., the host 204 or user of host 204) to set an expiration period for data objects 206 or classes of data objects 206. When the associated expiration period is due, the computing apparatus 200 can perform actions defined by the host 204. Actions can include, by way of example, one or more of the following: 1) purging or deleting the data object 206 securely or non-securely; 2) converting or transforming the data object 206 to a different format (e.g., from raw data to a .jpg file, from audio format to .mp3, etc.); 3) compressing the data object 206 using lossless or lossy compression methods; and 4) Transferring the data object 206 to another storage medium 210 either on the same computing apparatus 200 or in a separate computing apparatus 212 for data archival.

Secure deletion can include operations such as writing blank data (such as, e.g., 00s or FFs) into all bytes of the data object 206 or writing random data into the data object 206. Data can then be re-read from the data object 206 to verify if the data of the data object 206 was overwritten with the blank data (e.g., 00s or FFs). Non-secure deletion can include indicating in the file system that the data object was deleted, while leaving data for the data object 206 on the storage device. In some example embodiments, software running remotely or local to the computing apparatus 200 can perform a low-level scan of the storage device and can recover most if not all the data of the deleted data object 206.

Secure purges can include certified erase procedures that produce an electronic certificate of successful erasure of the data object 206, or procedures known as write/read/verify procedures that verify that an erasure actually occurred. If a data object 206 is to be transferred out to a different storage medium 210, the computing apparatus 200 can set a flag associated with the data object 206 to indicate such transfer is to take place to the local host 204. If the storage medium 110 is an active drive running a protocol such as transmission control protocol (TCP), the storage medium 110 can send messages indicating transfer is to take place to a known remote archival host (not shown in FIG. 2) or directly to remote storage mediums (e.g., storage medium 210) to allow remote archival hosts or storage media to pull the expired data object from the storage medium 110. Alternatively, the storage medium can push the expired data object 206 to the archival host/storage medium. Any of the above operations can be performed when the host 204 is in standby mode, as long as power remains to the computing apparatus 200 at least for the performance of the operation.

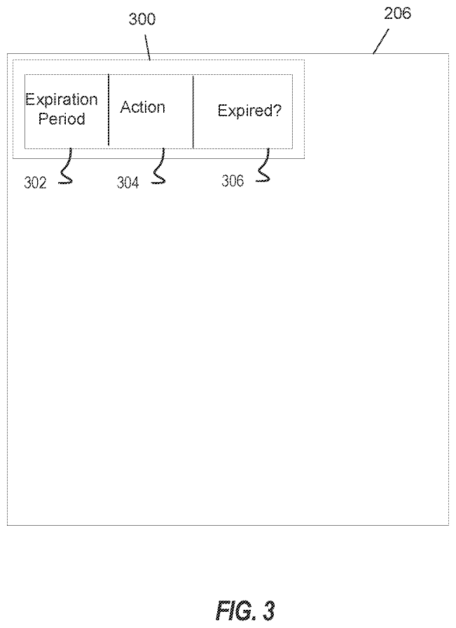

The host 204 should have the ability to set metadata (e.g., file system metadata) for each data object 206 stored in the storage medium 110. An example data object 206 is shown in FIG. 3.

FIG. 3 is a block diagram of a data object 206 including metadata 300 according to example embodiments. Metadata 300 can be included as additional metadata in a file system. While metadata 300 is shown as being part of the data object 206 in FIG. 3, metadata can additionally or alternatively be stored separately from the data object 206, either locally to storage medium 210 or remotely in a separate database (not shown in FIG. 3). These metadata 300 can include expiration information 302 about the expiration period for the data object 206. The expiration information 302 can be associated with other data objects (not shown) that may be of similar types as the data object 206. The metadata 300 can also include action information 304 regarding the type of action to be performed on the data object 206, responsive to expiration of the expiration period indicated in expiration information 302. Such actions can be selected by the host 204 (FIG. 2), either manually by a user of the host 204 or through a data analysis mechanism.

Some example data analysis mechanisms include rule-based analysis according to data object 206 type. For example, all data objects 206 that include sound files may be subject to one type of action (e.g., automatic deletion, or compression). Other data analysis mechanisms include artificial intelligence or machine learning mechanisms. These data analysis mechanisms can detect typical usage patterns of data objects 206 on the system to help predict which operations might be best to perform on expired data objects 206. For example, if host 204 typically compresses sound files, the data analysis mechanism may suggest that the computing apparatus 200 perform compression on later expired sound file data objects. As another example, raw picture files can be converted to another format such as .jpg or other standard image format to reduce file size.

Another example of data analysis can include predicting based on trends to decide on the operations to perform. For example, if sound data objects 206 (e.g., .wav data objects or other sound media data objects) are typically compressed at the end of the life cycle, users can be prompted to compress sound data objects 206 at the time the data objects 206 are created or soon thereafter, or some time period before the end of the data object 206 life cycle. Similarly, if raw picture data objects 206 are typically compressed at the end of the data object 206 life cycle, users can be prompted to do a conversion before the end of the life cycle. Operations can also include always, or by default, converting a particular type of image data object 206 automatically if data analysis has shown that the user that has always or most often done such conversion for that type of data object 206. In other examples, data objects 206 can be automatically moved to external archive storage or deleted.

Referring again to FIG. 2, the computing apparatus 200 (through use of the processing circuitry 202) can monitor the plurality of data objects 206 to detect presence of data objects 206 that have not been accessed for a threshold period of time. Responsive to detecting that a data object of the plurality of data objects 206 has not been accessed for that threshold period of time, the computing apparatus 200 can determine whether to perform an operation on that data object. The threshold period of time can be user defined and can be set individually for each data object 206, each data object 206 type (e.g., sound file, text file, etc.), for each group of data objects 206, or for any unit (e.g., folder or directory) of storage medium 210. The threshold period of time can be measured in any time unit, and range from several seconds to several months, depending on user preference, data object 206, etc. In some examples, the threshold period of time may be shorter, for example on the order of several seconds, for example, greater than or equal to 10 seconds and less than or equal to 10 minutes. In other embodiments, the threshold period of time may be on the order of several days, for example, greater than or equal to one day but less than or equal to one month. In other embodiments, the threshold period of time may be on the order of several months, for example, greater than or equal to one month but less than or equal to one year. The computing apparatus 200 can determine whether to perform the operation by examining file system metadata 300 associated with the data object 206. The file system metadata 300 includes (but is not limited to) expiration information 302 of the data object 206 and an indication 304 of the operation to be performed responsive to expiration of the data object 206. Other fields can be included, such as an indication 306 as to whether the data object 206 is expired, or other fields that can already be part of a file system. The operation to be performed on the expired data object 206 can include any of the operations described above, including deleting the data object 206, purging the data object 206, converting the data object 206, compressing the data object 206, or transferring the data object 206 to another storage medium 210. When the computing apparatus 200 detects that the time limit for a data object is expired, the computing apparatus 200 will mark that data object as expired and will provide an instruction, including identification information identifying the data object, to handler circuitry 208, whereupon the handler circuitry 208 will perform the associated action on the data object.

The handler circuitry 208 will determine what operation to perform on the data object. The handler circuitry 208 can determine the operation perform by checking if there is already a predetermined action to be taken (as set by the host 204 and based on metadata 300 associated with the data object 206) or the handler circuitry 208 can employ methods in data science to determine what action to take on that expired data object. In either case, the handler circuitry 208 may then perform the determined operation on the data object. Data analysis methods can include rule-based analysis or machine learning that will determine what type of actions to take to an expired data object. The training for the machine learning can be done externally by, for example, the host 204 or remote system (not shown in FIG. 2). The host 204 or remote system can provide training results 214 to be stored on the storage medium 110 or other component of the computing apparatus 200. The host 204 or other remote system can provide any updated training results 214 for storage thereon.

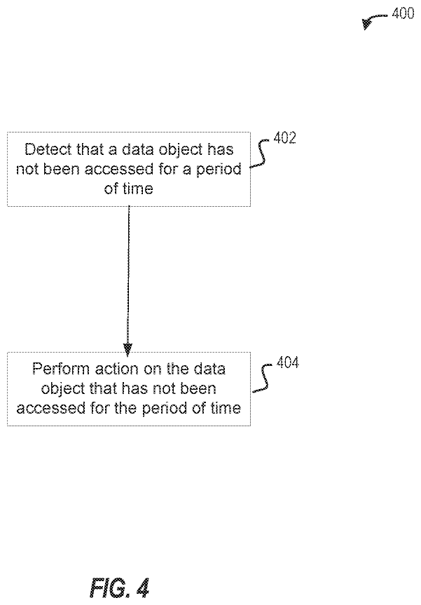

FIG. 4 is a flow diagram of a method 400 for data object life cycle handling. The example method 400 can be performed by components of a computing apparatus, such as the computing apparatus 200 (FIG. 2), which has included in one housing a storage medium 110 and processing circuitry 202, such a computing apparatus 200 being saleable as a single unit.

The example method 400 can begin with operation 402 with the processing circuitry 202 detecting that a data object of a plurality of data objects 206 stored on the storage medium 110 has not been accessed for a threshold period of time.

The example method 400 can continue with operation 404 with the processing circuitry 202 determining whether to perform an operation on the data object 206. The operation can include one or more of deleting the data object 206, purging the data object 206, converting the data object 206, compressing the data object 206, or transferring the data object 206 to another storage medium (e.g., storage medium 210 (FIG. 2)). This determining can be made by examining file system metadata 300 (FIG. 3) associated with the data object 206. As described above with reference to FIG. 3, the file system metadata 300 can include, among other information, an expiration period of the data object 206 and an indication of the operation to be performed responsive to expiration of the data object 206. In some examples, the operation to be performed on expired data objects 206 can be specified based on rule-based analysis according to the type of data object 206, or on machine learning results stored on the storage medium 110.

Devices and methods according to embodiments helps reduce computation needs at host devices by offloading the handling of expired data objects to the storage media that store those data objects. Such methods can also aid in implementation of data retention policies in which data objects are to be purged periodically or after a defined amount of time. Devices and methods according to embodiments can also provide power savings by allowing certain backup/purge operations even when computing system hosts are in standby or low-power mode.

The methods, techniques, and/or processes described in this disclosure, including those attributed to the processor, or various constituent components, may be implemented, at least in part, in hardware, software, firmware, or any combination thereof. For example, various aspects of the techniques may be implemented within one or more processors, including one or more microprocessors, DSPs, ASICs, FPGAs, or any other equivalent integrated or discrete logic circuitry, as well as any combinations of such components. The term “processing apparatus,” “processor,” or “processing circuitry” may generally refer to any of the foregoing logic circuitry, alone or in combination with other logic circuitry, or any other equivalent circuitry.

Such hardware, software, and/or firmware may be implemented within the same device or within separate devices to support the various operations and functions described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

When implemented in software, the functionality ascribed to the systems, devices and techniques described in this disclosure may be embodied as instructions on a computer-readable medium such as RAM, ROM, NVRAM, EEPROM, FLASH memory, STRAM, RRAM, magnetic data storage media, optical data storage media, or the like. The instructions may be executed by one or more processors to support one or more aspects of the functionality described in this disclosure.

In the preceding description, reference is made to the accompanying set of drawings that form a part hereof and in which are shown by way of illustration several specific embodiments. It is to be understood that other embodiments are contemplated and may be made without departing from (e.g., still falling within) the scope or spirit of the present disclosure. The preceding detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g., 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The implementations described above, and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

Example methods and devices were described with reference to FIGS. 1-4. It is apparent to one skilled in the art that elements or processes from one embodiment may be used in combination with elements or processes of the other embodiments, and that the possible embodiments of such methods and devices using combinations of features set forth herein is not limited to the specific embodiments shown in the figures and/or described herein. Further, it will be recognized that timing of the processes and the size and shape of various elements herein may be modified but still fall within the scope of the present disclosure, although certain timings, one or more shapes and/or sizes, or types of elements, may be advantageous over others.

What is claimed is:

1. A system comprising:
a storage medium comprising a plurality of data objects; and
a computing apparatus comprising processing circuitry operatively coupled to the storage medium, the computing apparatus configured to:
monitor the plurality of data objects to detect presence of data objects that have not been accessed for a threshold period of time; and
responsive to detecting that a data object of the plurality of data objects has not been accessed for that threshold period of time, determine whether to perform an operation on the data object, the operation including one or more of deleting the data object, purging the data object, converting the data object, compressing the data object, or transferring the data object to another storage medium.

2. The system of claim 1, wherein the computing apparatus is configured to determine whether to perform the operation by examining file system metadata associated with the data object.

3. The system of claim 2, wherein the file system metadata includes an expiration period of the data object and an indication of the operation to be performed responsive to expiration of the data object.

4. The system of claim 1, wherein the processing circuitry is part of a system-on-a-chip (SOC).

5. The system of claim 4, wherein the SOC further includes handler circuitry, and wherein the computing apparatus is configured to:
responsive to expiration of the data object, provide an instruction, including identification information identifying the data object, to handler circuitry.

6. The system of claim 5, wherein the handler circuitry is configured to:
determine what operation to perform on the data object; and
perform the determined operation on the data object.

7. The system of claim 6, wherein the handler circuitry determines the operation to perform on the data object based on metadata associated with the data object.

8. The system of claim 6, wherein the handler circuitry is configured to determine the operation to perform on the data object based on rule-based analysis according to a type of the data object.

9. The system of claim 6, wherein the handler circuitry is configured to determine the operation to perform on the data object based on machine learning results stored on the storage medium.

10. The system of claim 1, wherein the computing apparatus is configured to perform the monitoring and the determining while the system is in a standby mode.

11. A non-transitory computer-readable medium including instructions that, when implemented on a processor, cause the processor to perform operations including:
monitoring a plurality of data objects on a storage device coupled to the processor;
detecting that a data object of the plurality of data objects has not been accessed for a threshold period of time; and
responsive to the detecting, determining whether to perform an operation on the data object, the operation including one or more of deleting the data object, purging the data object, converting the data object, compressing the data object, or transferring the data object to another storage device.

12. The non-transitory computer-readable medium of claim 11, wherein the operations further include determining whether to perform the operation by examining file system metadata associated with the data object, wherein the file system metadata includes an expiration period of the data object and an indication of the operation to be performed responsive to expiration of the data object.

13. The non-transitory computer-readable medium of claim 12, wherein the operations further include:
responsive to expiration of the data object, providing an instruction, including identification information identifying the data object, directing an indicated operation to be performed on the data object.

14. The non-transitory computer-readable of claim 13, wherein the operations further include:
determining the indicated operation based on at least one of:
the file system metadata associated with the data object;
rule-based analysis according to a type of the data object; and
machine learning results stored on the storage device.

15. A method for data object life cycle handling, the method comprising: responsive to detecting, by processing circuitry of a storage medium, that a data object of a plurality of data objects stored on the storage medium has not been accessed for a threshold period of time, determining whether to perform an operation on the data object, the operation including one or more of deleting the data object, purging the data object, converting the data object, compressing the data object, or transferring the data object to another storage medium.

16. The method of claim 15, wherein determining whether to perform the operation is performed by examining file system metadata associated with the data object.

17. The method of claim 16, wherein the file system metadata includes an expiration period of the data object and an indication of the operation to be performed responsive to expiration of the data object.

18. The method of claim 17, further comprising:
determining the operation to take based on metadata associated with the data object.

19. The method of claim 17, further comprising:
determining the operation to take based on rule-based analysis according to a type of the data object.

20. The method of claim 17, further comprising:
determining the operation to take based on machine learning results stored on the storage medium.

21. A system comprising:
a storage device; and
a host computer communicatively coupled to the storage device, the host computer configured to set file system metadata of a plurality of data objects stored on the storage device and the storage device configured to, responsive to detecting that a data object of the plurality of data objects has not been accessed for a threshold period of time, access the file system metadata corresponding to the data object to determine whether to perform an operation on the data object, the operation including one or more of deleting the data object, purging the data object, converting the data object, compressing the data object, or transferring the data object to another storage device.

22. The system of claim 21, wherein the file system metadata includes an expiration period of the data object and an indication of the operation to be performed responsive to expiration of the data object.

23. The system of claim 22, wherein the host computer is configured to indicate the operation to be performed on the data object based on a machine learning algorithm.
